(19) United States
(12) Patent Application Publication
(10) Pub. No.: US 2024/0249246 A1
(43) Pub. Date: Jul. 25, 2024

(54) VERIFIED AUTOMATED EMPLOYMENT SCREENING SYSTEM

(71) Applicant: Employment Screening Plus LLC, Greenwood Village, CO (US)

(72) Inventors: Andrew D. Carr, Greenwood Village, CO (US); Frank Richards, Denver, CO (US)

(73) Assignee: Employment Screening Plus LLC, Greenwood Village, CO (US)

(21) Appl. No.: 18/421,770

(22) Filed: Jan. 24, 2024

Related U.S. Application Data
(60) Provisional application No. 63/441,132, filed on Jan. 25, 2023.

(51) Int. Cl. G06Q 10/1053

(52) U.S. Cl. CPC G06Q 10/1053

(57) ABSTRACT

Systems and methods to provide verified automated employment screening are described. In one aspect, a system collects, synthesizes, analyzes, and communicates historical employment data of employees and of employers to provide a verified screening service to a user. Employment data from multiple employers, other verified data sources, and/or the employee candidate are used to calculate a set of scores for the candidate employee. Any conflict between data sources is automatically resolved. The system employment scores may include an employee screening score and projected employment longevity score. A potential employer may select data used to generate the system scores, set analytical parameters, and filter available data. The system scores may be compared against employment benchmark data. The employment data may be used to calculate an employer score which may be compared against employment benchmark data. In some embodiments, artificial intelligence is employed toward resolving data conflicts or performing employee candidate assessments.

### CROSS-REFERENCE TO RELATED APPLICATION

This application is a nonprovisional patent application of and claims the benefit of U.S. Provisional Patent Application No. 63/441,132 titled “Verified Automated Employment Screening System” filed Jan. 25, 2023, the disclosure of which is hereby incorporated herein by reference in entirety.

### FIELD

The disclosure relates generally to systems and methods to provide verified employment screening, and specifically to systems and methods to collect, synthesize, analyze, interpret and communicate employment historical data of employees and employers.

### BACKGROUND

Conventional approaches to the screening and hiring of employees or the assessment of employers as long-term workplaces are commonly ad hoc, subjective, inaccurate, manual, qualitative and not comprehensive nor uniform. The existing and conventional approaches to employment screening and hiring result in a mismatch between employee and employer, leading to short employee tenure and reduced workforce productivity, among other things.

Every day, approximately 200,000 Americans are hired and 200,000 are fired. Only the company doing the hiring and firing and some disparate siloed vendors (e.g., Human Resources by way of HR software systems, Payroll Services entities, etc.) have any records of employee or employer hiring and firing. There is no verified truth source of any particular person's employment history and related information pertinent to making an informed hiring decision. For example, over 40% of employee candidate resumes have material errors or omissions. The resulting mismatch between employee and employer creates high turnover in, for example, entry level service jobs of about 85% per year. Employee turnover is a large cost to businesses and a primary source of poor quality. Many new hires commonly simply fail to show up for accepted employment or abandon their jobs during training,

There exists no standardized metric or method to provide screening of potential employees or employers which would increase the matching of employee and employer and thereby increase workforce productivity. In contrast, a standardized system and metric exists for providing a credit rating for individuals, i.e., the credit score. The credit score enables Americans to use their credit cards over 100 million times each day and to take out over $18 million in mortgages and other loans. Credit scores accurately and honestly track borrowings and payments. Lenders trust borrowers based on their credit score, and borrowers can choose between lenders, who are competing for the borrower's business. Without credit reporting, each lender would have to decide on each loan and each borrower, one at a time with no or limited borrowing and payment history. Furthermore, borrowers care about their credit score and are more responsible as a result.

The concept of a credit score for providing a standardized credit measure or metric, that is a credit score, to numerically assess a person's ability to take on debt may be applied to assessing a person's ability to take on a job as an employee by way of a standardized employee metric, or to an employer's ability to retain an employee by way of a standardized employer metric. A system and method to generate, analyze, and present such employment scores or metrics is provided in the disclosure. Such employment scores, for each of a particular potential employee and a particular potential employer, reduce the conventional mismatch between and employee hire and the employer, thereby addressing the problems of conventional approaches to the screening and hiring of employees or the assessment of employers.

### SUMMARY

Systems and methods providing verified automated employment screening are described. The “verified automated employment screening system” of the disclosure may be referred to as “system” and the method of use of the verified automated employment screening system may be referred to as “method.” In one aspect, the system collects, synthesizes, analyzes, and communicates employment historical data of employees and employers to provide a verified and accurate screening service to a user. Employment data from multiple employers of a particular potential employee are used to provide outputs of value for screening of employees, such as, for example, calculations of an employee screening score and the likelihood of a particular employee or group of employees leaving their employment over a certain period of time (aka projected longevity). The term “verified” means accurate or truthful as established by evidence or independent means. In the disclosure, the phrase “verified data” or the term “verified” when describing data, such as employment data, means data that is deemed accurate or truthful and is typically not data solely provided by a job applicant or employee, but rather data provided by, for example, a previous or current employer or a verified data source, such as a government agency e.g. the Internal Revenue Service.

The verified automated employment screening system allows employers to add to the database or codes (selectively not Personally Identifiable Information) which correspond to things such as the employee's trainer, their manager, their incentive structure, etc. The system may then return to employer's data analytics broken down by these codes to improve the employers' internal practices.

Additionally, in addition to full access to system scoring (note: the various scoring et al outputs of the verified automated employment screening system of the disclosure may comprise both an “ESP score” and a “longevity score;” other scores or values are possible) such as ESP scoring and projected longevity, employers may access the systems through a secure portal to customize their own employee screening score and/or projected longevity by adding additional quantitative and empirical information such as attendance records, work punctuality i.e. showing up to work on time, performance results, patterns and trends. Stated another way, an employer may engage the verified automated employment screening system using their own systems, such as an in-house database, analytics, models, user interface, and the like. As an example, employers may be allowed to apply weighted averages to these elements thereby tailoring a score and/or projected longevity. (Such user input or setting of analytical parameters is described in more detail below). Also, employers may be able to use and/or compare any system score, such as ESP score and projected longevity, with their customized model. Further, an employer may be able to provide qualitative data associated with employee data, such qualitative data including, e.g., employee performance reviews, employee attendance, employee sales performance, etc.

The verified automated employment screening system may also provide projected trends by tracking and measuring turnover based on root cause analysis which may include turnover by hiring class (before, during, and after training), by trainer, by supervisor/manager, by client, by campaign and by other elements), etc. In many if not most embodiments, such an analysis, or any analysis performed by the verified automated employment screening system, will not use and not even have access to the actual names of the persons involved (e.g., the trainer name, the supervisor or manager name) but instead will be provided reference values such as codes that indicate a particular person, such reference values or codes only decipherable by the party providing the data. For example, a particular employer may provide data with actual manager names provided as an alphanumeric (e.g., MX005), with only that particular employer knowing that manager M005 by actual name.

In some embodiments, Artificial Intelligence and/or Machine Learning may be used ongoing to further analyze and optimize the system's and/or the employers' customized scoring and projected longevity. Any of the produced system scores, such as the employee screening score and projected longevity, may be compared against employment benchmark data. A system user may provide analytical settings or threshold values for employment score generation and/or for comparison against benchmark data. The employment data and projected longevity may also be used to calculate an employer score, which may also be compared against employment benchmark data.

The phrases “intelligent system,” “artificial intelligence,” “bot” or “Bot,” and “AI” mean a machine, system or technique that mimics human intelligence.

The phrase “machine learning” or “ML” means a subset of AI that uses statistical techniques to enable machines to improve at tasks with experience.

The phrases “neural networks” and “neural nets” means an AI construction modeled after the way adaptable networks of neurons in the human brain are understood to work, rather than through rigid predetermined instructions.

In addition, the verified automated employment screening system may return to an employer a graphical comparison of the employment history an applicant submits to the prospective employer to the data in the system. Jobs in the system yet not in the job applicant's application would be highlighted, as would jobs in the system showing a materially (e.g., 1 month) different duration than provided on the job applicant's application.

In one embodiment, a verified automated employment screening system is described, the system comprising: a logic engine comprising a computer processor, the computer processor operating to: receive employment data from a plurality of data sources comprising a plurality of employers, receive benchmark employment data comprising average tenure data, and calculate one or more system scores comprising a first employee candidate screening score; a system database having a non-transitory computer-readable storage medium, the system database storing the employment data and storing the benchmark employment data, the employment data comprising at least: i) a first employer data set from a first employer and associated with a first employee candidate, and ii) a second employer data set from a second employer and associated with the first employee candidate; and a user interface operating to present the one or more system scores to a user and to receive one or more data analysis settings comprising a below average threshold percentage and an above average threshold percentage; wherein: the logic engine has machine-executable instructions operating to: automatically calculate the average tenure data, the below average threshold percentage, and the above average threshold percentage; and render, on the user interface, the first employee candidate screening score.

In one aspect, the first employee candidate screening score is automatically calculated in real-time. In another aspect, each of the first employer data set and the second employer data set comprise employee date of hire, employee date of termination, employee beginning job title, employee ending job title, and eligibility for rehire. In another aspect, the first employer data set comprises a first employer data set usage requirements set and the second employer data set comprises a second employer data set usage requirements set. In another aspect, the logic engine further comprises machine-executable instructions operating to adhere to the first employer data set usage requirements set and adhere to the second employer data set usage requirements set. In another aspect, at least one of the first employer data set and the second employer data set are encrypted. In another aspect, the logic engine further comprises machine-executable instructions operating to render on the user interface a first employee candidate timeline comprising a set of first employee candidate timeline tenure blocks defined by the first employer data set and the second employer data set. In another aspect, the logic engine further comprises machine-executable instructions operating to render on the user interface any first employee candidate timeline tenure gaps that exceed a selectable tenure gap threshold.

In another embodiment, a method of using a verified automated employment screening system is described, the method comprising: providing a verified automated employment screening system comprising: a system database having a non-transitory computer-readable storage medium, the system database configured to store employment data, the employment data comprising at least: i) a first employer data set from a first employer and associated with a first employee candidate, and ii) a second employer data set from a second employer and associated with the first employee candidate; a logic engine comprising a computer processor, the computer processor operating on the system database; and a user interface; receiving, by the computer processor, the employment data; storing, by the computer processor, the employment data on the system database; receiving, by the computer processor, benchmark employment data comprising average tenure data; storing, by the computer processor, the benchmark employment data on the system database; receiving, by the user interface, one or more data analysis settings comprising a below average threshold percentage and an above average threshold percentage; calculating, by the computer processor, a first employee candidate screening score based at least on the first employer data set, the second employer data set, the average tenure data, the below average threshold percentage, and the above average threshold percentage; and rendering, by the computer processor on the user interface, the first employee candidate system score relative to the benchmark employment data.

In one aspect, the first employee candidate screening score is automatically calculated in real-time. In another aspect, each of the first employer data set and the second employer data set comprise employee date of hire, employee date of termination, employee beginning job title, employee ending job title, and eligibility for rehire. In another aspect, the first employer data set comprises a first employer data set usage requirements set. In another aspect, the method further comprises the step of adhering to the first employer data set usage requirements set and adhering to the second employer data set usage requirements set. In another aspect, the method further comprises the step of rendering, on the user interface, the first employee candidate timeline comprising a set of first employee candidate timeline tenure blocks defined by the first employer data set and the second employer data set. In another aspect, the method further comprises the step of rendering, on the user interface, any first employee candidate timeline tenure gaps that exceed a selectable tenure gap threshold.

In yet another embodiment, a verified automated employment screening system is described, the system comprising: a logic engine comprising a computer processor, the computer processor operating to: receive employment data from a plurality of data sources comprising a plurality of employers, receive benchmark employment data comprising average tenure data, and calculate one or more a system scores comprising a first employee candidate screening score and a second employee candidate screening score; a system database having a non-transitory computer-readable storage medium, the system database storing the employment data and storing the benchmark employment data, the employment data comprising at least: i) a first employer data set from a first employer and associated with a first employee candidate, ii) a second employer data set from a second employer and associated with the first employee candidate, iii) a third employer data set from a third employer and associated with a second employee candidate, ii) a fourth employer data set from a fourth employer and associated with the second employee candidate; and a user interface operating to present the one or more system scores to a user and to receive one or more data analysis settings comprising a below average threshold percentage and an above average threshold percentage; wherein: each of the first employer data set, the second employer data set, the third employer data set, and the fourth employer data set comprise employee date of hire, employee date of termination, employee beginning job title, employee ending job title, and eligibility for rehire; and the logic engine has machine-executable instructions operating to: automatically calculate the first employee candidate screening score based at least on the first employer data set, the second employer data set, the average tenure data, the below average threshold percentage, and the above average threshold percentage; automatically calculate the second employee candidate screening score based at least on the third employer data set, the fourth employer data set, the average tenure data, the below average threshold percentage, and the above average threshold percentage; render, on the user interface, the first employee candidate screening score and the second employee candidate screening score; and render, on the user interface, each of: i) a first employee candidate timeline comprising a set of first employee candidate timeline tenure blocks defined by the first employer data set and the second employer data set, and ii) a second employee candidate timeline comprising a set of second employee candidate timeline tenure blocks defined by the third employer data set and the fourth employer data set.

In one aspect, each of the first employer data set, the second employer data set, the third employer data set, and the fourth employer data set comprise employee date of hire, employee date of termination, employee beginning job title, employee ending job title, and eligibility for rehire. In another aspect, the first employer data set comprises a first employer data set usage requirements set, the second employer data set comprises a second employer data set usage requirements set, the third employer data set comprises a third employer data set usage requirements set, and the fourth employer data set comprises a fourth employer data set usage requirements set. In another aspect, the logic engine further comprises machine-executable instructions operating to adhere to each of: i) the first employer data set usage requirements set, ii) the second employer data set usage requirements set, iii) the third employer data set usage requirements set, and iv) the fourth employer data set usage requirements set. In another aspect, at least one of the first employer data set, the second employer data set, the third employer data set, and the fourth employer data set are encrypted.

By way of providing additional background, context, and to further satisfy the written description requirements of 35 U.S.C. § 112, the following references are incorporated by reference in their entireties: U.S. Pat. No. 11,188,864 to Abraham and U.S. Pat. No. 8,554,584 to Hargroder; and U.S. Pat. Publ. Nos. 2015/0142685 to Willis; 2004/0186852 to Rosen; 2021/0133684 to Janjua; 2013/0166358 to Parmar; 2021/0065124 to Reeves; and 2016/0180291 to Beck.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

Various embodiments or portions of methods of manufacture may also or alternatively be implemented partially in software and/or firmware, e.g., analysis of signs. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The verified automated employment screening system may, in some embodiments, use or leverage derivative analytics.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a depiction of one embodiment of a verified automated employment screening system of the disclosure;

FIG. 2A is a flow chart of one embodiment of a method of use of the verified automated employment screening system of FIG. 1;

FIG. 2B is a flow chart of another embodiment of a method of use of the verified automated employment screening system of FIG. 1;

FIGS. 3A-B are one embodiment of employment data used to calculate an employee screening score;

FIGS. 4A-B are one embodiment of employment data used to calculate an employer score;

FIG. 5A is one embodiment of a display of analytical results of the verified automated employment screening system of FIG. 1, the results of an employee candidate relative to benchmark employment data;

FIG. 5B is one embodiment of a display of analytical results of the verified automated employment screening system of FIG. 1, the results of a set of employee candidates relative to benchmark employment data;

FIG. 6A is one embodiment of employment data used to calculate an employee longevity score; and

FIG. 6B is one embodiment of a display of employee longevity score.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, the descriptions are intended to cover alternatives, modifications, and equivalents as can be included within the spirit and scope of the described embodiments as defined, for example, by the appended claims.

The verified automated employment screening system collects, synthesizes, analyzes, and communicates historical employment data of employees and of employers to provide a verified screening and assessment service to a user. Employment data from multiple employers or other verified data sources for a particular potential employee are used to calculate a set of scores or metrics for the particular, potential employee. Such system scores may include an employee screening score and a projected longevity score. A system user such as a potential employer may select data used to generate the system scores, set analytical parameters, and filter or restrict available data. The system scores may be compared against employment benchmark data. The employment data may also be used to calculate an employer score which may similarly be compared against employment benchmark data.

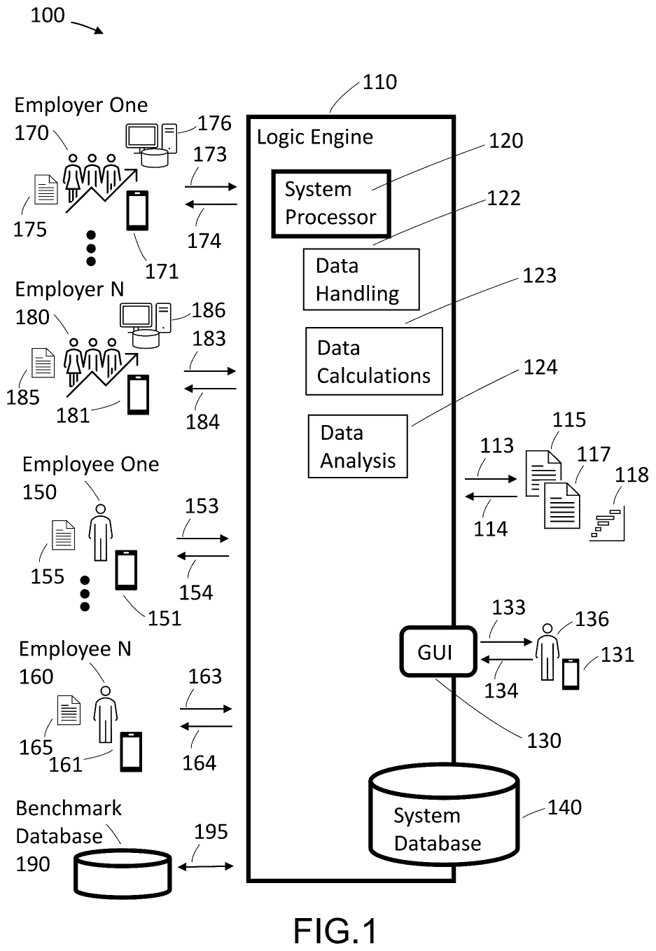

The disclosed devices, systems, and methods of use will be described with reference to FIGS. 1 through 6A-B. Generally, systems and methods to collect, synthesize, analyze, and communicate employment historical data of employees and employers are described.

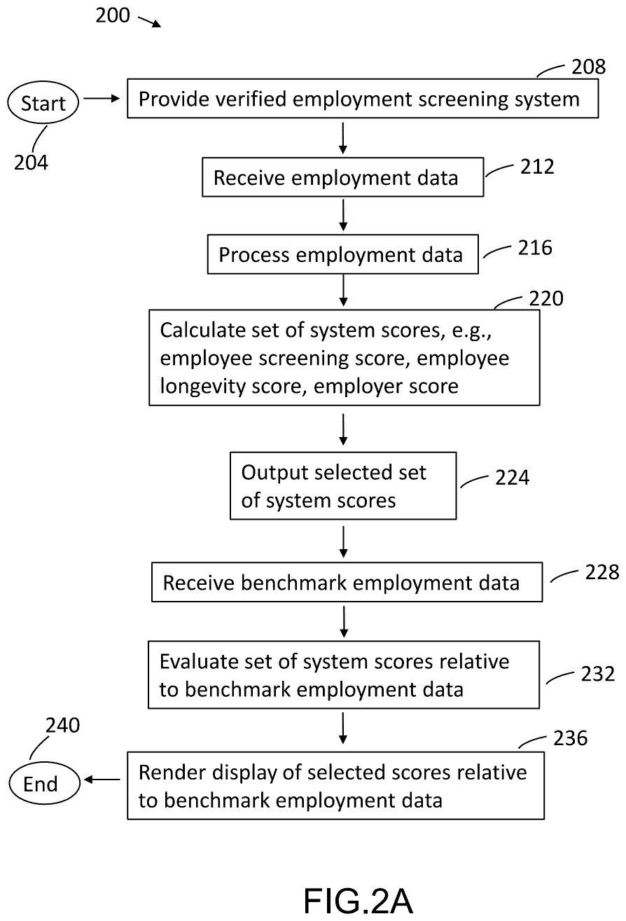

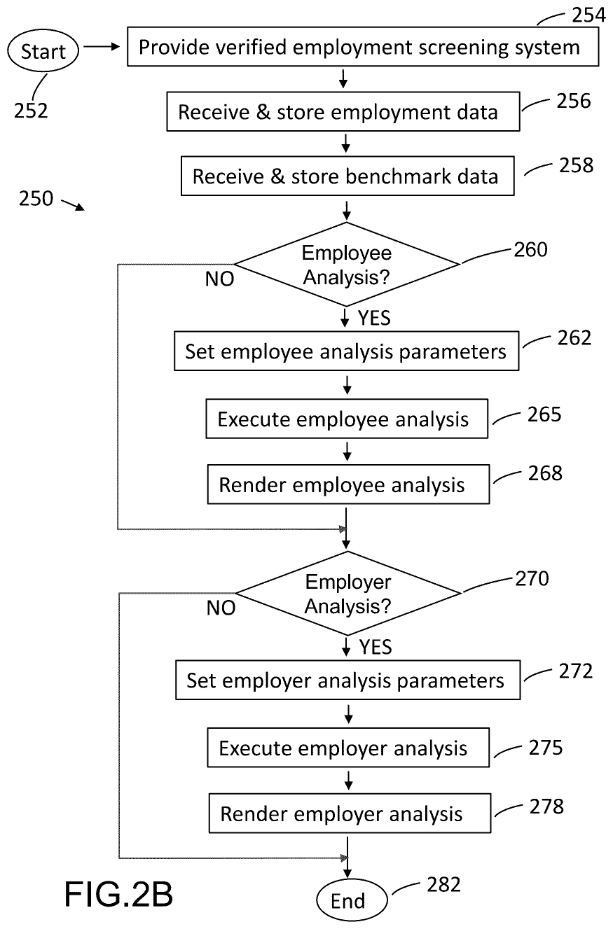

With attention to FIG. 1, one embodiment of a verified automated employment screening system 100 is depicted. The “verified automated employment screening system” may be referred to as “screening system” or simply “system.” With attention to FIGS. 2A and 2B, respective embodiments of a method of use 200 of the verified automated employment screening system 100 of FIG. 1 is depicted. A method of use of the verified automated employment screening may be referred to as “screening system method” or “system method” or simple “method.” Stated another way, the phrase “screening system” or simply the term “system,” or the phrase “screening method” or simply the term “method,” may refer to any of the embodiments of the disclosure which involve any collection of the features described in the disclosure and is not limiting.

Generally, the verified automated employment screening system provides many features and benefits, such as:
Gathering and owning employee authorized first party employment data from employers
Combining all or substantial portions of these data to create written and graphical timelines
Appending other available data (to include specialized data from employers, to include employer computer systems or databases)
Creating a score encompassing employment and other data to aid employment decisions. (A higher score may be associated with more experience, fewer long gaps between jobs, fewer below average tenure jobs, and more above average tenure jobs, etc.)
Providing employers and prospective employers with a “black box” of accessible information to avoid any potentially discriminatory or problematic information from influencing an employment decision. Specifically, employers may screen candidates through the “black box” system without having access (unless legally required) to any discriminating and demographic information including but not limited to ethnicity, gender and age.
Creating a summary and/or a score about employers themselves and/or their employees projected longevity, individually or as a group, based on, e.g., their own reported empirical employee and employer data.
Creating an online, and/or offline, method for employees to dispute employer-provided data and for Consumers to access an online secure portal to track, manage and optimize the score including tools, tutorials, and guidance to help improve their score.
Enabling any employee or prospective employee to be a participant or opt out of the system database.
Enabling advisement to prospective employees on the general ways they might improve their Employee Score, or projected longevity.
Providing employees with access to verified data about themselves
Creating a database of employment data analogous to the Credit History.
Offering third party verified skills-based testing in a particular field of work to enhance an individual score.
First party approval may be secured by the operator/owner of the system and/or by the system to gather, hold, and use the information when each person is hired, or when employees of a Client provide authorization.
   To include their dates of employment, titles, and whether they are eligible for rehire
   The system will append other data
These data will form the basis of an Employment Score upon which employers and job seekers aka applicants can both rely
These data along with other data may also form the basis of a projected longevity for a particular employee or prospective employee.
Employers will no longer blindly hire people who skip from job to job or who have unexplained, hidden gaps in their resumes
Job seekers will want a higher employment score and projected longevity and will gain leverage over prospective employers when they have one resulting in improved odds of being hired, negotiated better compensation, improved career tracking opportunities and more.
The system will gain first party access and ownership of the data when the job seeker fills out the application for employment, and at other times in defined circumstances.
   Analogous to the approval for credit reporting allowed under all borrowing
The system will get termination information from each employer
Employees may have access to learn, dispute, and make comments on their employment (score) information
   Analogous to the access and rights everyone has with the credit reporting agencies
   Employees may access an online secure portal to track, manage and optimize the score including tools, tutorials, and guidance to help improve their score.
The system may also develop a score for Employers based on their empirical employer and employee information (e.g., is their turnover rate above average? Do they mark an unusual percentage of terminated employee's ineligible for re-hire)
   This information may be available to job seekers
Data provided to prospective employers may be “Black boxed” and stripped of all racial, gender and other potentially discriminatory information where required or allowed by law and based on Employer requests. For example, some employers (or governmental entity) may request racial or other sensitive data to support their DEI programs. Stated another way, a client, employer, data provider, or other any user may choose or select the system data to be received and/or processed. In this way, an employer, e.g., may select only the data they want (and nothing more) when evaluating a potential employee
   Will reduce the prospective employer's legal exposure
The database may be enhanced from many other sources and can be resold in anonymized or de-anonymized forms (depending on employee authorization) for a myriad of purposes including, for example:
   Recruiting
   Research
   Marketing of many products based on job changes
   Other
The system may allow and account for differences in data treatment by source and normalize the information from many sources with those differences in mind. Some sources of verified automated employment screening system data may, for instance, not provide racial or other demographic information, while others will. The system may draw the maximum allowed correlations between sources, based on the restrictions from each source, and, in addition, restrict outputs of any selectable kind based on the composite restrictions of the various data sources. For instance, a source of system data may disallow use of race in data analysis when that source provides a data update. The verified automated employment screening system may then not ascribe a race to that individual in the database unless the system receives information on that individual's race from a separate, validated source.
The verified automated employment screening system may operate in a near real-time manner or at least as fast as in a near real-time manner. In one embodiment, the system operates in real-time. The term “real-time” means an event or function that is processed instantaneously, such as graphics in a 3D video game as rendered by a computer's video card wherein there is no noticeable delay experienced by the user.
The database may be enhanced from many other sources and maybe resold in anonymized or de-anonymized forms (depending on employee authorization)

With attention to FIG. 1, the verified automated employment screening system 100 comprises a logic engine 110 comprising a computer or system processor 120, a user interface such as a Graphical User Interface (GUI) 130, a system database 140 having a non-transitory computer-readable storage medium, and a benchmark database 190. (The phrase “user interface” or “UI”, and the phrase “graphical user interface” or “GUI”, means a computer-based display that allows interaction with a user with aid of images or graphics).

The logic engine 110 operates to receive employment data from multiple data sources, such as a plurality of employers shown as employer one 170 through to Employer N 180, and/or one or more employees, such as employee one 150 through to employee N 160. A particular employer may be associated with a particular data set, e.g., a first employer may be associated with a first employer, a second employer may be associated with a second data source, etc. Generally, a data set provided by an employer will comprise employee job history with that employer. In some embodiments, the data sets may reference the employee through indirect means to protect the identity of the employee, such as through, e.g., a code such as an alphanumeric that is known only to the employer. The system may have the ability to decipher such codes in order to assess the employee as a candidate employee (e.g., to create employment scores as described below), such assessment in coordination with the employer so as to protect the identity of the employee. Stated another way, the system may link employee candidate job histories in order to generate job candidate assessments without actually knowing the identity of the job candidate (e.g., may return to a potential employer an assessment of a job candidate using a code for that candidate such that the employer may internally decipher the candidate's identity). Other data sources are possible, such as third-party private data sources, government data sources to include e.g. employment and tax agencies, and from the employee candidate themselves (e.g., from a candidate's resume or job application). Note that a given candidate employee may be associated with a different set of employment databases than another.

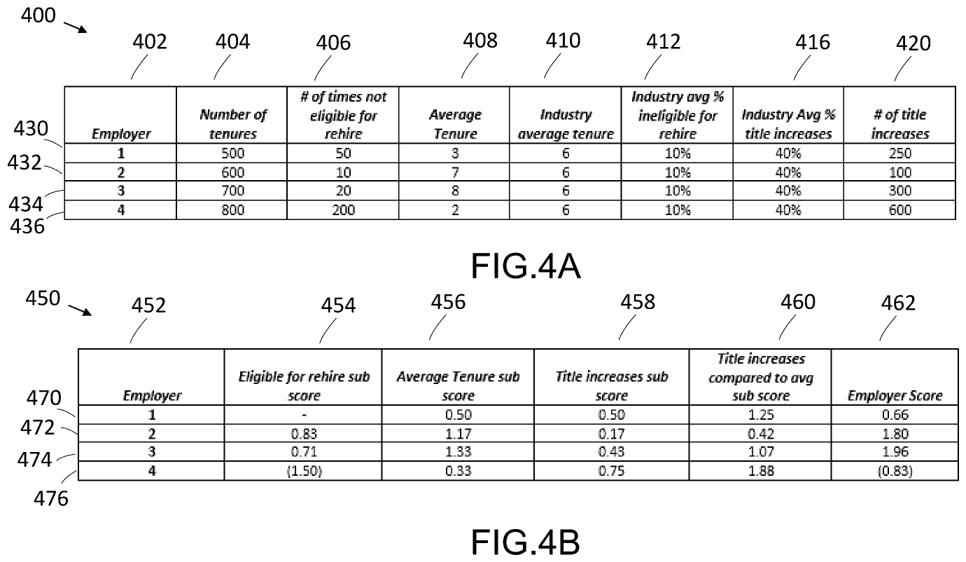

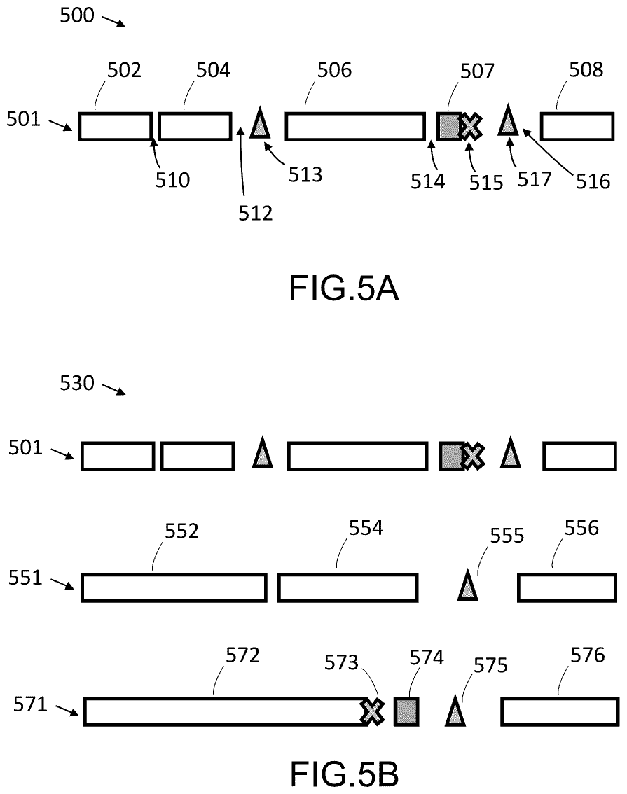

The logic engine 110, by way of the system processor 120, may comprise one or more of a data handling module 122, a data calculations module 123, and a data analysis module 124. The logic engine 110 operates to receive employment data to calculate any number of metrics, scores, or values, such as, for example, an employee screening score 115, an employer score 117, and/or a longevity score (not shown). (See e.g., FIGS. 4-6 as to sample data and sample data calculations). (The various scores or metrics produced by the verified automated employment screening system are generally termed “system scores.”) The logic engine 110 may also evaluate one or more of the system scores, such as the employee screening score aka the screening score or employee score 115, relative to the data provided by the benchmark database 190 to render a display of one or more employee screening scores 115 relative to benchmark employment data, identified as element 118 in FIG. 1 (and described in more detail in FIG. 5).

A user 136 may interact with the logic engine 110 by way of GUI 130 and/or user device 131. The user 136 may input or enter or select options or enter data for the operation of the verified automated employment screening system 100. For example, the user 136 may select if one or both of an employee analysis and an employer analysis is to be performed (See, e.g., FIG. 2B). Furthermore, the user 136 may input or enter data that sets or establishes parameters for the calculations of various system scores or enter data such as threshold data that enables analytics relative to the benchmark employment data of the benchmark database 190. As an example, in one embodiment the user provides data analysis settings including a below average threshold percentage and an above average threshold percentage (such values described below). Note that the user 136 may be of varied type, to include an employer, a potential employee, an auditing agency such as a government auditing agency, etc.

The employment data may be provided to logic engine 110 in any of several ways as known to those skilled in the art, such as through traditional direct (wired) connection, wireless connection such as by smart device or smart phone, etc. Wireless communications may be, e.g., Bluetooth, Bluetooth low energy, ZigBee, cellular networks to include 4G and 5G, WiMAX, and other wireless networking types or protocols. The phrase “smart device” means a wired or wireless context-aware electronic device capable of performing autonomous computing and connecting to other devices for data exchange.

The logic engine 110 may operate to receive employment data from one or more data sources and to provide data in return to such data sources. For example, the logic engine 110 may receive data regarding a first employee from a first employer; the logic engine 110 may then share that data with the first employee or perform operations on that data. As an example, an employer data set may include one or more of: employee date of hire, employee date of termination, employee beginning job title, employee ending job title, and eligibility for rehire.

Each of the employment data sources may have dedicated input data streams and output data streams relative to the logic engine 110, and dedicated means of data transfer. More specifically, employer one 170 may have output data stream 173 to logic engine 110 and input data stream 174 from logic engine 110, such data streams operated through any of various communication means known to those skilled in the art, such as by way of portable communication device 171 (e.g., smartphone). Employer N 180 may have output data stream 183 to logic engine 110 and input data stream 184 from logic engine 110, such data streams operated through any of various communication means known to those skilled in the art, such as by way of portable communication device 181 (e.g., smartphone).

Similarly, employee one 150 may have output data stream 153 to logic engine 110 and input data stream 154 from logic engine 110, such data streams operated through any of various communication means known to those skilled in the art, such as by way of portable communication device 151 (e.g., smartphone). Employee N 160 may have output data stream 163 to logic engine 110 and input data stream 164 from logic engine 110, such data streams operated through any of various communication means known to those skilled in the art, such as by way of portable communication device 161 (e.g., smartphone).

Each of the employment data sources have terms and conditions (any set of such “terms and conditions” may collectively be referred to as data “use conditions” or as “employer data set usage requirements”) specific to the data source. For example, employer one 170 provides data to logic engine 110 that has terms and conditions 175 and employer N 180 provides data to logic engine 110 that has terms and conditions 185. Such terms and conditions may include expiration of data, limits on distribution (e.g., cannot be distributed other than as an aggregate value, may only be distributed to employee associated with the data, and the like), limits on access (e.g., only non-management data may be accessed, only management data may be accessed, executive data may not be accessed, etc.). Employee one 150 provides data to logic engine 110 subject to terms and conditions 155 and employee N 160 provides data to logic engine 110 subject to terms and conditions 165. Benchmark database data 190 may have terms and conditions as well (not shown) and/or data produced or calculated by logic engine may have terms and conditions (not shown). In one embodiment, the terms and conditions may equate to the above-mentioned “black box” of data wherein only identified or selectable data, as identified or selected by a particular employer, is provided or accessible by that employer.

The terms and conditions of any particular data set may be established in any of several ways. For example, a use condition data file may be linked with a particular set of data, the use condition data file describing the use conditions i.e. the terms and conditions for use of the particular data set. Alternatively, or additionally, a user may input terms or conditions on a case-by-case basis, meaning each time the verified automated employment screening system 100 is engaged the terms and conditions of a data set are established or set. In another example, the verified automated employment screening system 100, upon any request to perform an analysis to include calculation of one or more system scores, may query one or more databases or data sources (via the cloud, e.g.) to obtain the latest version of use conditions aka terms and conditions for each and every particular set of data. In one embodiment, a user (such as a system administrator user with special privileges) may override one or more terms and conditions of a data set to, for example, establish more restrictive terms and conditions.

Each of the employer data sources may have in-house or company computer systems or capabilities that may interact with the verified automated employment screening system 100. For example, employer one 170 may comprise employer one computer system 176 and employer N 180 may comprise employer one computer system 186. An employer computer system, such as employer one computer system 176 and employer N computer system 186, may include a system processor, a user interface such as a GUI, a database, modeling capabilities and/or analysis capabilities, for example. The employer computer system may provide, e.g., qualitative data such as employee sales performance, attendance, reviews, etc. such that the employer may make internal projections of turnover and the effectiveness of different trainers, training methods, managers, etc. Such functions or capabilities of an employer computer system may be termed “employer analytics.”

Benchmark database 190 may have communication 195 with logic engine 110 by any means known to those skilled in the art, such as through direct (wired) connection, wireless connection such as by smart phone, etc.

In one embodiment, one or more of the data communications of the system 100 comprise or are enabled by a system app that performs one or more of the functions described above with respect to a user device. For example, the system app may allow the employer one 170 user, by way of the system app, to input and/or receive data from logic engine 110, establish analytical parameters, etc. As another example, the user 136 may use a system app to interact with logic engine 110 and/or data analysis module 124 (in addition to or alternatively from the GUI 130). (The term “app” or “application” means a software program that runs as or is hosted by a computer, typically on a portable computer to include a portable computer such as user devices or smart phones and includes a software program that accesses web-based tools, APIs and/or data).

The logic engine 110 may output data, such as employee score 115, employer score 117, and/or displays 118 of one or more employee screening scores 115 relative to benchmark employment data in display 118, by way of output data stream 113. The logic engine 110 may receive data regarding such data by way of input data stream 114.

Data handling module 122 may provide processing, by way of system processor 120, such as data filtering, data verification, data conformance, data encryption, data de-encryption, and/or data quality checking. For example, data received from an employer one 170 via data stream 173 may be verified as indeed provided by a legitimate employer (rather than, e.g., falsely provided by a third party). As another example, the data handling module 122 may also perform a validation or conformance check that the data received conforms or adheres to terms and conditions of the receipt of such data, such as ensuring that a requirement that the data be free of ethnicity, gender, age, etc. (that is, any potentially discriminatory information) of the employee. In one embodiment, the data handling module 122 checks that data from employer one 170 conforms or adheres to terms and conditions 175 and/or that employer N 180 data conform or adheres to has terms and conditions 185. A non-conformance may trigger rejection of the data, cessation of the requested (by a user) data run of the system, and/or filtering of the data to satisfy the terms and conditions. An amalgamated or composite terms and conditions of data associated with a particular employee may then be generated, such terms and conditions defaulting, in one embodiment, to the most restrictive terms and conditions. For example, employee one data from employer one regarding a particular employee A may require that the data be anonymized relative to employee name, while data from a second employer requires no such restriction. The data handling 122 may attach the more restrictive condition (data is anonymized relative to employee name) to all data associated with employee A, to include the employee screening score generated by the data calculations 123 module.

The data handling module 122 may provide processing, by way of system processor 120, to anonymize tracking fields. For example, employers may be able to attach or provide codes indicating data parameters such as which trainer an employee had, who their manager was, etc. to the data provided. While the verified automated employment screening system will typically not know or be able to access, for instance, the identity of an employee's manager, the system may return analytics to the employer broken down by the provided codes for different managers (as such, the employer will be able to understand or decipher the meaning of the codes, yet the system is not so aware). Such a capability would enable, for example, the determination that some managers are better (by a numerically established value) at retaining employees; such managers discoverable through post analysis sorting of filtering.

Stated another way, the data handling 122 may include anonymizing the data. For example:
The system anonymizes and encrypts the information for each source so that no one, including the system, can identify the name, social security number or identity of the person whose data is collected.
system anonymizes the PII (personally identifiable information) data in a way which allows the system to accurately link the data from various system data providers about a single person.
When a person provides written authorization to the system to share the information the system has gathered about them, the system will de-encrypt and de-anonymize some or all of the data about that person and provide it to the entity or entities which the person has authorized.

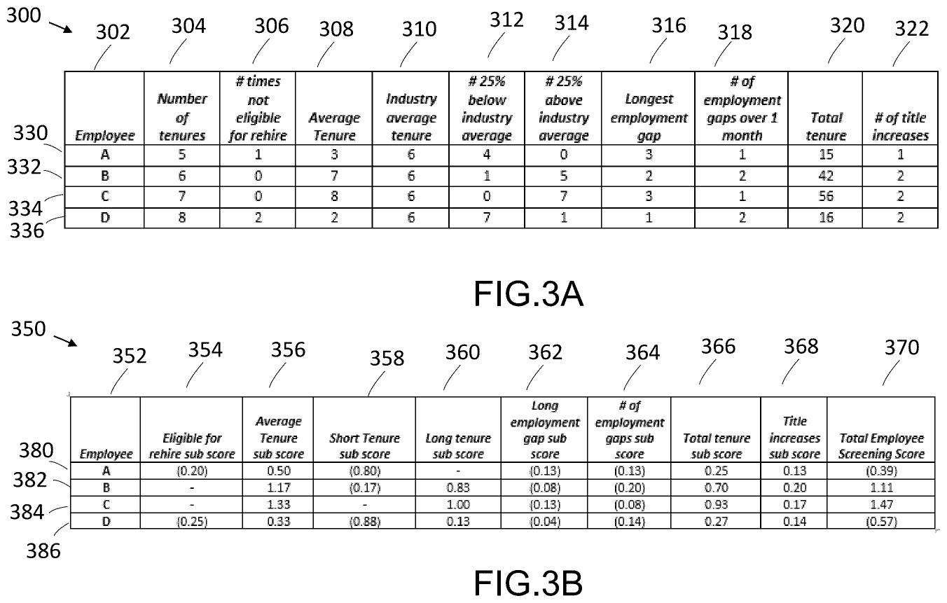

Data calculations module 123 may perform, by way of system processor 120, calculations of employee score 115 and/or employer score 117, as described in more detail in FIGS. 3A-B and 4A-B. As an example, in one embodiment, the calculations module 123 may calculate an employee candidate screening score based at least on the first employer data set, the second employer data set, the average tenure data, the below average threshold percentage, and the above average threshold percentage.

Data analysis module 124 may perform, by way of system processor 120, analysis of employment data relative to employee score 115 and/or employer score 117, to include enabling calculations to provide a display of employee screening score relative to benchmark data (see FIG. 5). A user 136 may interact with data analysis module 124 by way of GUI 133 and/or device 131.

Any or all of the various data modules 122, 123, 124 of the system processor 120 may engage with or leverage AI and/or ML technology in executing operations. For example, employment data and/or benchmark data may be used to train AI and ML engines to establish one or more data analysis parameters (e.g., threshold values, as described below). Other uses of AI and/or ML are possible.

The databases associated with the verified automated employment screening system 110, such as benchmark database 190 and system database 140, may comprise a computer-readable storage media, in one embodiment. It is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

In one embodiment, the databases associated with the verified automated employment screening system 110 and/or all or some elements of the system 110 operate in the cloud. (The phrase “cloud computing” or the word “cloud” refers to computing services performed by shared pools of computer resources, often over the Internet). In one embodiment, some or all of the computing or services or operations of the logic engine 110 are performed in the cloud.

In one embodiment, one or more of the user devices (e.g., 171, 181, 151, 161, 131) and the logic engine 110 operate in a respective client-server arrangement. (The phrase “client-server” or “client-server architecture” means a shared computer architecture in which the server hosts, delivers and manages the majority of the resources (e.g., computing resources) and services to be consumed by a client. There may be multiple clients connected to a single server over a network or internet connection.

FIG. 2A is a flow chart of one embodiment of a method of use 200 of the verified automated employment screening system 100 of FIG. 1. Note that in some embodiments, some functions (e.g., any of the identified elements numbered 208-236) may be absent, occur in a different order, or include other functions or steps not shown. A method of use 200 depicted in FIG. 2 will now be described, with reference to aspects and features of the system of FIG. 1 described above.

After starting at step 204, the method 200 proceeds to step 208. At step 208, the verified automated employment screening system is provided, such as that described in FIG. 1. After completing step 208, the method 200 proceeds to step 212.

At step 212, the verified automated employment screening system receives employment data, such as from any combination of employer 1 through employer n (and/or any other sources of employment data the system may be engaged), employee one through employee N, and benchmark data. After completing step 212, the method 200 proceeds to step 216.

At step 216, the data received is processed by one or more of data handling module, data calculation module, and data analysis module. As described above, the data processing may include, in one example, by way of data handling module, a check on satisfaction of terms and conditions of the data and/or generation of an amalgamated or compound terms and condition set for that data. (Such compound terms and conditions data set being an example of data stored in the system database 190). After completing step 216, the method 200 proceeds to step 220.

At step 220, the data calculations module calculates one or more of a set of system scores, such as, for example, an employee screening score, an employer score, and an employee longevity score. The set of system scores are then stored in the system database. After completing step 220, the method 200 proceeds to step 224.

At step 224, the one or more set of system scores, as selected by a system user, are output by the verified automated employment screening system to, for example, a system user by way of the system's user interface. (The user may be, for example, an employer seeking to screen potential employees). After completing step 224, the method 200 proceeds to step 228.

At step 228, the verified automated employment screening system receives benchmark employment data from one or more benchmark databases. Such data may include graphical and/or tabular data. In one embodiment, some or all of the benchmark data have associated terms and conditions (of use). After completing step 228, the method 200 proceeds to step 232.

At step 232, the verified automated employment screening system evaluates the employee screening score and/or an employer score relative to the benchmark employment data from the one or more benchmark databases. Such evaluation may be interactive with user by way of the system user interface. After completing step 232, the method 200 proceeds to step 236.

At step 236, the verified automated employment screening system renders one or more system scores, such as the employee screening score, employee longevity score, and/or an employer score relative to the benchmark employment data (or in isolation, meaning without reference to any benchmark) on the user interface. After completing step 236, the method 200 proceeds to step 240 and the method 200 ends.

As mentioned above, in some embodiments some functions may be absent, or steps not shown. For example, one or more analytical parameters used, for example, in the calculations, analysis, and/or presentations may be provided or selected or set by the user.

FIG. 2B is a flow chart of one embodiment of a method of use 250 of the verified automated employment screening system 100 of FIG. 1. Note that in some embodiments, some functions (e.g., any of the identified elements numbered 254-278) may be absent, occur in a different order, or include other functions or steps not shown. A method of use 250 depicted in FIG. 2B will now be described, with reference to aspects and features of the system of FIG. 1 described above.

After starting at step 252, the method 250 proceeds to step 254. At step 254, the verified automated employment screening system is provided. After completing step 254, the method 250 proceeds to step 256.

At step 256, the system receives and stores (in system database, e.g.) employment data. The employment data may include data from potential employee applicants (e.g. resumes, employment applications), data from employers, data from third party data providers, and/or data from government databases or sources (e.g. government employment agencies, government tax agencies). The employment data may have associated terms and conditions common for all the data or data fields or data providers/sources or unique to each data field and/or data provider/source. After completing step 256, the method 250 proceeds to step 258.

At step 258, the system receives and stores (in system database, e.g.), a set of employment benchmark data from one or more sources, such as data from employers, data from third party data providers, and/or data from government databases or sources (e.g. government employment agencies, government tax agencies). For example, a state government database may provide data as to the average tenure of employees in particular job categories. The benchmark data may have associated terms and conditions common for all the data or data fields or data providers/sources or unique to each data field and/or data provider/source. After completing step 258, the method 250 proceeds to step 260.

At step 260, a query is presented to the user as to whether the system is to perform an employee analysis. If the response is Yes, the method proceeds to step 262. If the response is No, the method proceeds to step 270.

At step 262, parameters for the employee analysis are set or input or established, such as by a user. In some embodiments, one or more such parameters are set automatically, such as by query or engagement with a data file that provides employee analysis parameters. The employee analysis parameters may, for example, comprise a threshold value for a gap in employment that would create a “flag” or other notation may be set (e.g., a value of 1 month may be set, or 6 weeks, or 2 months). After completing step 262, the method proceeds to step 265.

At step 265, the employee analysis is executed or performed. The analysis is performed in conformance with any terms and conditions attached to or associated with the underlining (employment and/or benchmark) data. For example, a particular employer data set may only allow their data from the prior or earlier years to be used (vs. the current year) in any analysis. After completing step 265, the method proceeds to step 268.

At step 268, the results of the employee analysis are rendered, such as on a user display and/or user app. After completing step 268, the method proceeds to step 270.

At step 270, a query is presented to the user as to whether the system is to perform an employer analysis. If the response is Yes, the method proceeds to step 272. If the response is No, the method proceeds to step 282 and the method 250 ends.

At step 272, parameters for the employer analysis are set or input or established, such as by a user. In some embodiments, one or more such parameters are set automatically, such as by query or engagement with a data file that provides employer analysis parameters. The employer analysis parameters may, for example, comprise an industry average for ineligible for rehire (See FIG. 4A, column 412, e.g.). After completing step 272, the method proceeds to step 275.

At step 275, the employer analysis is executed or performed. The analysis is performed in conformance with any terms and conditions attached to or associated with the underlining (employment and/or benchmark) data. After completing step 275, the method proceeds to step 278.

At step 278, the results of the employer analysis are rendered, such as on a user display and/or user app. After completing step 278, the method proceeds to step 282 and the method 250 ends.

The data provided to the verified automated employment screening system may originate from a variety of sources with particular terms and conditions, as described above.

Employment data may include, for example with respect to an individual employee:
Average tenure at previous jobs compared to industry average. The industry average may be calculated from collected data, or public data, or both, with a preference being given to collected data. (In one embodiment, this element will be 75% of weight of the most important element in calculating an Employee Score)
Number, percentage and recency of any job tenures 25% or less than the industry average. The industry average may be calculated from collected data, or public data, or both, with a preference being given to collected data. (In one embodiment, this element will be 75% of weight of the most important element in calculating an Employee Score). Increases or decreases in title from job to job (In one embodiment, this element will be 25% of weight of the most important element in calculating an Employee Score)
Number and percentage of time marked not eligible for rehire (In one embodiment, this element will be the most important element in calculating an Employee Score)
Number of job tenures above 25% of industry average. The industry average may be calculated from collected data, or public data, or both, with a preference being given to collected data. (In one embodiment, this element will be 25% of weight of the most important element in calculating an Employee Score). Number and recency of employment gaps greater than 1 month
Longest employment gap (In one embodiment, this element will be 25% of weight of the most important element in calculating an Employee Score).
·Total length of time in jobs comparable to the one they applied for or are in (In one embodiment, this element will be 25% of weight of the most important element in calculating an Employee Score).

Employment data may include, for example with respect to an individual employer:
Average tenure compared to industry average (The industry average may be calculated from system collected data, or public data, or both, with a preference being given to system collected data). (In one embodiment, this element will be 75% of weight of the most important element in calculating an Employer Score)
% marked ineligible for rehire compared to average
% that leave with a higher title than they were hired with (In one embodiment, this This element will be 25% of weight of the most important element in calculating an Employer Score)
And the same compared to industry average

Note that the above numerical values (e.g., 25%, 75%) are selectable parameters that may be established automatically or entered by a user. In one embodiment, one or more threshold values are set automatically through data residing or associated with the data source (e.g., a data source for benchmark data may include data as to such threshold values). In another embodiment, one or more threshold values are set by an AI and/or ML subsystem, such an AI and/or ML trained by way of the set of benchmark data.

Data may also be provided from third parties, such as, for example credit scores, background check data, and skill tests and credentials. In one embodiment, data is provided from an employer payroll system, human relations (“HR”) system or other employer system.

In one embodiment, no employment data used by the verified automated employment screening system is employee self-reported.

In one embodiment, data sources will be the company at which they are working or applying and may also include other companies' or organizations' data to include background check data, and/or government data such as IRS data.

In one embodiment, other companies' data may be from those company's internal systems, or systems such as payroll services and HR related software that those companies use.

In one embodiment, an employee or prospective employee provides permission for the system to gather at least the following data and for the system to hold and own that data:
Date of hire
Date of termination
Beginning job title
Ending job title
For terminated employees, if they are eligible for rehire

FIGS. 3A-B present one embodiment of employment data, relative to employment benchmark data, used to calculate an employee screening score. Other data structures or data types are possible; FIGS. 3A-B present one non-limiting example. Other calculations (and weightings) are possible.

FIG. 3A presents a first set of data of four candidate employees (a “candidate”), respectively candidate Employees A through D in respective rows 330, 332, 334, and 336. All time data is in months (other time frames may be used in some embodiments, e.g., weeks or days). The columns are Employee identifier 302, number of tenures (i.e. jobs) 304, number of times the employee was not eligible for rehire 306 (e.g., as a result of a bad behavior at the tenure), average tenure (of the set tenures) 308, industry average tenure 310 (such data may come from benchmark data, as described above), number of tenures that are at or below 25% of the industry average 312 (here, as industry average is 6—see column 310—the 25% threshold is 4.5), number of tenures that are at or above 25% of industry average 316 (here, as industry average is 6, the 25% threshold is 7.5), longest employment gap 318, total tenure 320, and number of title increases 322. The term “tenure” means length of a job held.

Note that the setting of 25% as a threshold value for assessing both below an industry average value and above an average industry value is a setting that may be adjusted, either automatically or by a user. Such analytical parameters may alternatively be established by way of a data file or table accessed by the verified automated employment screening system.

FIG. 3B presents a second companion set of data of the same four candidate employees of FIG. 3A, respectively candidate Employees A through D in rows 380, 382, 384, and 386. The data of FIG. 3B is a continuation of the data of FIG. 3A, meaning the row of data for a particular employee is common between the two figures (e.g., Employee A at row 330 of FIG. 3A tracks with the data of Employee A at row 380 of FIG. 3B). All time data is in months.

A series of calculations are performed on each of the set of four candidate employees A, B, C, and D that provide insight into the employment posture of each of the candidate employees. The nine columns 354, 356, 358, 360, 362, 364, 366, 368, and 370 calculate values as indicated at column heading and defined below.

Column 354 presets a calculation of the eligible for rehire sub score, which reflects if a candidate employee has ever been deemed not eligible for rehire (which results in a negative score, such as found for each of candidate employees A and D). The greater the absolute value of the value in column 354, the greater the risk to the employer of hiring that candidate employee (because that candidate has an increased risk of being deemed not eligible for rehire). Column 354 is the result of dividing the value of column 306 by the value of column 304, and assigning a negative value to any non-zero computed result. A result of zero is shown as a dash in column 354. The negative values of candidates A and D are shown in the style of accounting, i.e. within paratheses.

Column 356 presents a calculation of the average tenure sub score, found by dividing the average tenure of column 306 value by the industry average tenure of column 310 value.

Column 358 presents a calculation of the short tenure sub score, found by dividing the 25% below industry average of column 312 value by the number of tenures of column 304 value, assigning a negative value for any calculation in which column 312 is non-zero. The larger the absolute value of the short tenure sub score the more risk (or less attractiveness) associated with the hiring of the particular employee candidate given the increased likelihood of a below industry average tenure of the candidate for the new employer.

Column 360 presents a calculation of long tenure sub score, found by dividing the 25% above industry average of column 314 value by the number of tenures of column 304 value. The larger the value of the long tenure sub score the less risk (or more attractiveness) associated with the hiring of the particular employee candidate given the increased likelihood of an above industry average tenure of the candidate for the new employer.

Column 362 presents a calculation of the long employment gap sub score, found by dividing the longest employment gap value of column 316 by 24. Note that the value of the denominator (24) may be set be established by the user.

Column 364 presents a calculation of the number of employment gaps sub score, found by taking 50% of dividing the number of employment gaps over 1 month value of column 318 by one less than the value of the number of tenures of column 304.

Column 366 presents a calculation of the total tenure sub score, found by taking 20% of dividing the total tenure of column 320 value by 12.

Column 368 presents a calculation of the title increases sub score, found by taking 50% of dividing the number of title increases of column 322 by one less than the value of the number of tenures of column 304.

And column 370 presents a calculation of the total employee screening score, found by a set of weighted additions of the calculated values in each of columns 354, 356, 358, 360, 362, 364, 366, and 368 as provided below:

Column 370=[(column 354)+(column 356×0.75)+(column 358×0.75)+(column 360×0.25)+(column 362×0.25)+(column 364×0.25)+(column 366×0.25)+(column 368×0.25)]

Note that the weightings applied (i.e., the 0.25 and the 0.75 weightings) are adjustable and may be set as analytical parameters as described above, e.g. a user may set or establish such weightings to be different values, to include 0.0, negative values, and values greater than 1. In one embodiment, as described above, one or more of such weightings are selectable parameters that may be established automatically or entered by a user. In one embodiment, one or more weightings are set automatically through data residing or associated with the data source (e.g., a data source for benchmark data may include data as to such threshold values). In another embodiment, one or more weighting values are set by an AI and/or ML subsystem, such an AI and/or ML trained by way of the set of benchmark data.

FIGS. 4A-B present one embodiment of employment data, relative to benchmark employment data, used to calculate an employer score. Other data structures or data types are possible. FIGS. 4A-B present one non-limiting example; other calculations (and weightings) are possible.

FIG. 4A presents a first set of data of four employers, respectively Employers 1, 2, 3, and 4 in rows 430, 432, 434, and 436. All time data is in months (other time frames may be used in some embodiments, e.g., weeks). The columns are Employer identifier 402, number of tenures 404, number of times an employee was not eligible for rehire 406, average tenure 408, industry average tenure 410 (such data may come from benchmark data, as described above), industry average percentage ineligible for rehire 412 (such data may come from benchmark data, as described above), industry average percentage title increases (such data may come from benchmark data, as described above), and number of title increases 420.

FIG. 4B presents a second set of data of the same four employers, respectively Employers 1, 2, 3, and 4 in rows 470, 472, 474, and 476. The data of FIG. 4B is a continuation of the data of FIG. 4A, meaning the row of data for a particular employer (e.g., Employer 1 at row 430 of FIG. 4A tracks with the data of Employer 1 A at row 470 of FIG. 4B). All time data is in months. The five columns 454, 456, 458, 460, and 462 calculate values as indicated at the respective column heading. A total employer score is provided in column 462 for each of the four employers of rows 470, 472, 474, 476.

Column 454 presets a calculation of the eligible for rehire sub score, which reflects if an employer's history or record of deeming employees not eligible for rehire (which results in a negative score, such as found for employer D). The greater the absolute value of the value in column 454, the greater the likelihood that an employee of that employer will be deemed not eligible for rehire. Column 454 is the result of calculating 1.0 minus the value of dividing the result of dividing the value of column 406 by the value of column 404, that (column 406)/(column 404) value divided by the value of column 412. A negative value is shown in the style of accounting, i.e. within paratheses. A zero value is shown as a dash (i.e., the value of column 454 for employer 1).

Column 456 presents a calculation of the average tenure sub score, found by dividing the average tenure of column 408 value by the industry average tenure of column 410 value.

Column 458 presents a calculation of the title increases sub score, found by dividing the number of title increases of column 420 by the value of the number of tenures of column 404.

Column 460 presents a calculation of the title increases compared to the industry average percentage title increases, found by dividing the value of the title increases sub score of column 458 by the industry average percentage title increases value of column 416.

And column 462 presents a calculation of the employer score, found by a set of weighted additions of the calculated values in each of columns 454, 456, 458, and 460 as provided below:

Column 462=column 454+(column 456×0.75)+(column 458×0.25)+(column 460×0.125)

Note that the weightings applied (i.e., the 0.25, the 0.125, and the 0.75 weightings) are adjustable and may be set as analytical parameters as described above, e.g. a user may set or establish such weightings to be different values, to include 0.0, negative values, and values greater than 1. (In one embodiment, as described above, one or more of such weightings are selectable parameters that may be established automatically (to include by or with aid of an AI and/or ML subsystem).

FIGS. 5A-B depict renderings generated by the verified automated employment screening system for one or more candidate employees based on data or system analysis of employment data and benchmark data.

FIG. 5A is one embodiment of a display 500 of analytical results of the verified automated employment screening system of FIG. 1, specifically the results of a single employee candidate 501 relative to benchmark employment data. The horizontal axis represents time. The depicted employee 501 has five tenures, 502, 504, 506, 507, and 508 with respective gaps in employment of 510, 512, 514, and 516. The depicted blocks of time for each previous job in the system's database are of a size proportional to the length of that job; tenure 506 is the longest tenure, and tenure 507 is the shortest tenure. Gaps 510 and 514 are within selectable threshold gap values (such values are analytical parameters that may be set or established by a user. (In one embodiment, as described above, one or more of such threshold gap values are selectable parameters that may be established automatically (to include by or with aid of an AI and/or ML subsystem).

Gaps 513 and 516 exceed the selectable threshold gap value (e.g., one month), resulting in a triangle icon 513, 517 positioned within the gap. Each of the length or tenure of tenures 502, 504, 506 and 508 are at or above a selectable tenure length, while tenure 507 is not, resulting in a shading for the tenure length. Also, because tenure 507 also resulted in a “not eligible to hire” designation upon the employee's departure, a shaded X is positioned at the end of the tenure 507. Other depictions are possible; FIG. 5A presents one non-limiting example. In one embodiment, job tenures that vary from the industry norm by more than 25% will also be highlighted, and/or increases and decreases in job titles are identified, e.g. by icons placed adjacent the appropriate tenure timeline block.

In one embodiment, the system may append other information about the employee or applicant to its database such as credit scores, background check results, publicly available data, third party data, publicly available IRS data and other data. Such data may also be factored into the (employment score, such as the employee screening score) and be provided to the employer or prospective employer.

A set of employees, such as a set of candidates for a common open employer position, may be presented above or below one another to provide a ready visual comparison of the set of candidate employees. FIG. 5B is one embodiment of a display of analytical results of the verified automated employment screening system of FIG. 1, the results of a set of employee candidates relative to benchmark employment data.

With attention to FIG. 5B, the results of analysis of three employee candidates are shown: candidates 501, 551, and 571. Candidate 501 is identical to that of FIG. 5A and thus is not described again in detail. Candidate 551 has three job tenures of 552, 554, and 556. A gap in employment i.e. tenure between tenure 554 and 556 is identified with a shaded triangle 55 because that gap exceeds a selectable threshold value. (Again, such a threshold value is an analytical parameter that is selectable by a user). Candidate 571 also has three tenures of 572, 574, and 576. Job tenure 574 does not satisfy a minimum threshold value for length of tenure (i.e. candidate 571 did not work long enough at that job to avoid flagging as “too short” of a tenure) and thus the time block for tenure 574 is shaded. Also, while the tenure 572 is relatively long, that job tenure resulted in a not eligible for rehire and thus a shaded X 573 is placed at the end of the time block for tenure 572. Lastly, the gap in time between tenures 574 and 576 exceeds a selectable threshold value and thus a shaded triangle 575 is placed between tenures 574 and 576. (Such a threshold value is an analytical parameter that is selectable by a user).

The rendering of analytical results of a set of employee candidates in the manner of FIG. 5B presents a useful tool for effective and efficient appraisal of employee candidates. In one embodiment, the verified automated employment screening may be configured to automatically identify or take action (e.g. remove from consideration) any employee candidate with selectable analytical results. For example, a candidate with more than one tenure gap that does not satisfy the tenure gap criteria is automatically removed from job hiring consideration (in the case depicted in FIG. 5B, this would remove candidate 501 given the two (triangle icon) length of tenure flags but not remove either of candidates 551 or 571). As another example, the system could automatically flag or identify or take action regarding candidates that have one or more not eligible for rehire designations (here, with respect to FIG. 5B, this would identify each of candidates 501 and 571 who each have such a shaded X not eligible for rehire icon, but not identify candidate 551 who has no such shaded X).

In one embodiment, some or all conditions or data values that affect (positively or negatively) an employee candidate's screening score may be accessible (or visually highlighted/identified so as to flag the employee candidate and/or associated data) for follow-up query. In one embodiment, the verified employment screening system does not assume to validate or access the rationale (or good or bad nature) of a particular characteristic of a candidate employee (e.g., the system does not assess the good/bad quality of a relatively short job tenure). In one embodiment, an AI and/or ML subsystem is used to assess or judge the relative merit (aka good/bad nature) of a relatively short job tenure or unexplained job gap by drawing from the data to determine if the gap was for understandable reasons (e.g. military service).

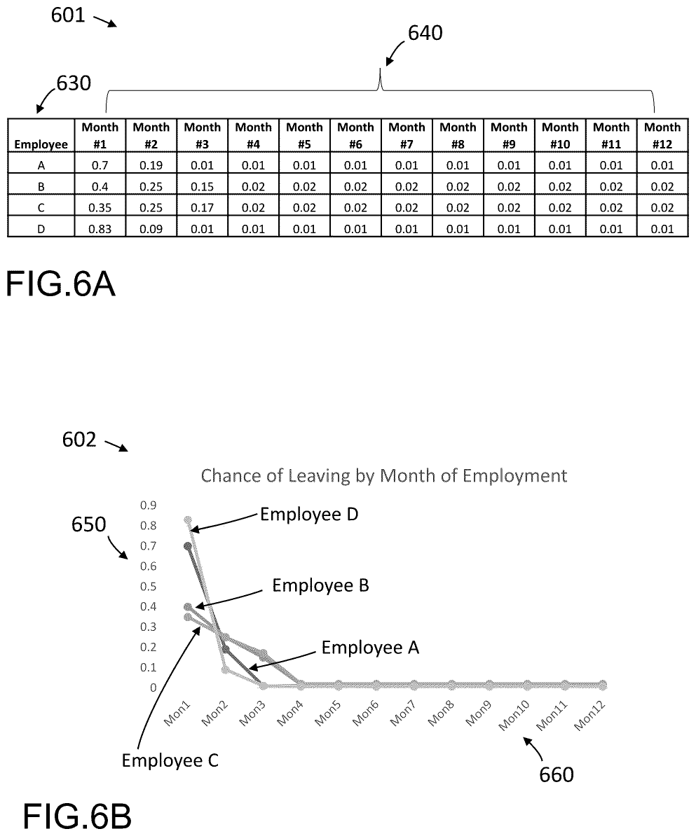

Other data analytics may be performed by the verified automated employment screening system. FIG. 6A presents one non-limiting example embodiment of employment data used to calculate an employee longevity score. Other data structures or data types are possible and other calculations (and weightings) are possible. FIG. 6B presents one embodiment of a display of the employee longevity scores of FIG. 6A. Other displays of longevity score are possible.

FIG. 6A presents a set of data of four employees, respectively Employees A through D, in column 630. The employee data of FIG. 6A is consistent with that of FIGS. 3A-B. For example, Employees A through D in column 630 have the same number of tenures 304 and same average tenures 308 as those of FIG. 3A. Specifically, employees A through D have average tenure of 3, 7, 8, and 2, respectively.

The projected longevity score is an estimate of how long an employer will keep an employee based on their job history and the other data provided to the verified automated employment screening system. One may analogize the set of system scores to credit scores as follows: payment history=employment history; credit score=employment score; decision to lend and at what interest rate=projected longevity. Note that each employer will have a unique, employer-specific minimum needed projected longevity for a new hire to close a business case for hiring that employee candidate.

The verified automated employment screening system calculates a longevity score (in months) for each of the employees A through D, as presented in the set of columns 640. At any particular month from hiring, an employee will hold a projected longevity score. The longevity score is a decimal value between 0.0 and 1.0 and may be equated to a percentage. For example, employee A in column 630 holds a longevity value of 0.7 at the end of one month from hiring, then a value of 0.19 at the end of month two from hiring, and a value of 0.1 at the end of month three from hiring. See data elements in the set of columns 640. The value of 0.7 equates to 70%. Thus, employee A has a 70% chance or likelihood that he will exit the employer within the first month of employment, and a 19% chance he will leave in the second month, etc. Further, these data may be considered in a cumulative manner, meaning, e.g., employee A has a (70%+19%=) 89% chance he will leave within the first two months of employment. Note that the longevity values are consistent with the average tenure of the particular employee, that is, the monthly longevity values net to the average tenure for that particular employee.

The longevity values may be presented as a display, such as provided in FIG. 6B. The set of longevity values of FIG. 6A are presented as y-axis 650 with time (in months) along x-axis 660 for the set of four employees (A through D). For example, employee D, who holds a chance of leaving at or by the end of month one value of 0.83 (see FIG. 6A), results in a data point at (month, longevity) of (1, 0.83). Other displays of longevity are possible. For example, a cumulative value of longevity with time may be presented. For example, returning to the example of employee A, values of (month, cumulative longevity score) of (1, 0.7), (2, 0.89), (3, 0.90), etc. may be presented.

The various system scores produced by the verified automated employment screening system may be presented to a user in any of several alternative or additive manners to those disclosed above, as known to those skilled in the art. For example, the system may calculate a comparison of a particular employee applicant's job history, as entered or provided by the applicant, to the data that the system has identified. Such a comparison may provide insight into the integrity of the employee applicant and/or accuracy of data provided by the employee applicant.

In some embodiments, the verified automated employment screening system has one or more of the below features:
provides first party collection of application for employment, resume (CV), hiring, employment and termination data
will interface with major HR and payroll platforms to gather this information seamlessly
employers may pay to know the score and/or job history and/or projected longevity of an applicant, a group of applicants, a current employee or group of employees.
employers may pay to access the “Black Box” application system.
employers may pay a monthly subscription to access the system.
Applicants or employers may pay for employer scores and longevity estimates
Consumers/Applicants may pay to access an online secure portal to track, manage and optimize the score including tools, tutorials, and guidance to help improve their score.
append other data, such as credit scores, and background check data, and skill tests and credentials to the database (but, in one embodiment, all will be provided by outside, responsible parties, not the applicant)
the system may notify employees and prospective employees via email, or regular mail when new information is added to the system's database.
Employees and prospective employees will have the ability to dispute, with evidence, any employer-provided data through an online portal.
clients may elect to have all employee information provided to a system client, or only a subset. For example, the system may have age, gender, or other sensitive information about the Employees in its database. Some employers will wish to know some sensitive items, others will prefer that the system provides only certain information and that the rest be a “black box” to that system client.
Employee screening Score and the Employer Score and Projected Longevity and the “Black Box” application system/portal and the system algorithms that create them may all be periodically reevaluated and revised to improve their usefulness.
The system may also provide Employees the option to authorize addition of data from approved third parties. Such third parties include but are not limited to skills testing companies and professional qualification results.
may allow employees or prospective employees to authorize the system to collect data on them from all available sources for a fee or for no charge. This option would apply to employees and prospective employees who have not already authorized the system to collect data on them by association with a system client.
anonymize all data stored in its database, and only allow data selected by system clients and approved by the employee to de-anonymized.
All data going into or out of the system may be encrypted prior to transmission. All data within the system may be encrypted at rest may provide all data in system database to employers or prospective employers and/or, scores using all available system data. This includes the option to provide lists of prospective employees to companies looking for new employees.
may allow employees or prospective employees to authorize data collection on them from all available sources for a fee or for no charge. This option would apply to employees and prospective employees who have not already authorized to collect data on them by association with a system client
A data provider (which may be a company, or other entity) provides information about a person. This information may be but is not limited to: dates of employment, employer, education or certification level attained, demographic information, credit information, salary information, etc. In one embodiment, all information provided by data source parties (other than the person seeking employment as an employee candidate), will have firsthand verifiable knowledge of the information, e.g. an employer data source will have firsthand verifiable knowledge of data supplied such as start date, end date, and any “not eligible for rehire” designation.
May notify employees and prospective employees via email when new data has added to database.
Employees may also rescind their approval to use data about them at any time through secure, verified, online means. Employees may receive online access to all the data about them in the system database through secure, verified online means.

Note that although verified automated employment screening system and method of use has focused on employment environments, the system and method may be applied in other environments. For example, the system may be applied in: payroll companies, business software companies e.g., Intuit, and HR software companies, Recruiting, Market Research, and other unrelated Fields.

In one embodiment, the verified employment screening system receives employment data that overlaps in an employee candidate's job history, the overlap at times in conflict. For example, a first data set e.g. from a particular employer may provide a start and end date in conflict with what the candidate provided in a resume for the start and end date of employment, or the particular employer may provide that the candidate, as a result of their employment with that employer, is not eligible for rehire, yet the candidate did not so disclose. The system may take any of several actions in such scenarios, to include, e.g., flagging or otherwise identifying such a data conflict in a visual display (e.g., that of FIGS. 5A-B) or providing a text output that identifies the conflict. Such identification has many benefits, including enabling the potential employer to ask the candidate about the data discrepancy. Also, the system may override one data source over the other through internal algorithms (to include, in one embodiment, with use of AI/ML techniques that, among other things is trained to determine the relative accuracy of various data sources and override data from the different data sources accordingly). In one such data overlap/comparison/resolution algorithm, the employee candidate's provided (in conflict) data is always overwritten with any other data source, under the assumption that the candidate's provided data is always of weakest accuracy. Furthermore, alternatively or additionally, a well-established data source known to have high reliability (e.g., a government data source such as the IRS) may always override any other data source.

The exemplary systems and methods of this disclosure have been described in relation to employment. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the methods have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A verified automated employment screening system comprising:
a logic engine comprising a computer processor, the computer processor operating to: receive employment data from a plurality of data sources comprising a plurality of employers, receive benchmark employment data comprising average tenure data, and calculate one or more system scores comprising a first employee candidate screening score;
a system database having a non-transitory computer-readable storage medium, the system database storing the employment data and storing the benchmark employment data, the employment data comprising at least: i) a first employer data set from a first employer and associated with a first employee candidate, and ii) a second employer data set from a second employer and associated with the first employee candidate; and
a user interface operating to present the one or more system scores to a user and to receive one or more data analysis settings comprising a below average threshold percentage and an above average threshold percentage;
wherein:
the logic engine has machine-executable instructions operating to:
automatically calculate the first employee candidate screening score based at least on the first employer data set, the second employer data set, the average tenure data, the below average threshold percentage, and the above average threshold percentage; and
render, on the user interface, the first employee candidate screening score.

2. The system of claim 1, wherein the first employee candidate screening score is automatically calculated in real-time.

3. The system of claim 1, wherein each of the first employer data set and the second employer data set comprise employee date of hire, employee date of termination, employee beginning job title, employee ending job title, and eligibility for rehire.

4. The system of claim 1, wherein the first employer data set comprises a first employer data set usage requirements set and the second employer data set comprises a second employer data set usage requirements set.

5. The system of claim 4, wherein the logic engine further comprises machine-executable instructions operating to adhere to the first employer data set usage requirements set and to adhere to the second employer data set usage requirements set.

6. The system of claim 1, wherein at least one of the first employer data set and the second employer data set are encrypted.

7. The system of claim 3, wherein the logic engine further comprises machine-executable instructions operating to render on the user interface a first employee candidate timeline comprising a set of first employee candidate timeline tenure blocks defined by the first employer data set and the second employer data set.

8. The system of claim 7, wherein the logic engine further comprises machine-executable instructions operating to render on the user interface any first employee candidate timeline tenure gaps that exceed a selectable tenure gap threshold.

9. A method of using a verified automated employment screening system comprising:
providing a verified automated employment screening system comprising:
a system database having a non-transitory computer-readable storage medium, the system database configured to store employment data, the employment data comprising at least: i) a first employer data set from a first employer and associated with a first employee candidate, and ii) a second employer data set from a second employer and associated with the first employee candidate;
a logic engine comprising a computer processor, the computer processor operating on the system database; and
a user interface;
receiving, by the computer processor, the employment data;
storing, by the computer processor, the employment data on the system database;
receiving, by the computer processor, benchmark employment data comprising average tenure data;
storing, by the computer processor, the benchmark employment data on the system database;
receiving, by the user interface, one or more data analysis settings comprising a below average threshold percentage and an above average threshold percentage;
calculating, by the computer processor, a first employee candidate screening score based at least on the first employer data set, the second employer data set, the average tenure data, the below average threshold percentage, and the above average threshold percentage; and
rendering, by the computer processor on the user interface, the first employee candidate system score relative to the benchmark employment data.

10. The method of claim 9, wherein the first employee candidate screening score is automatically calculated in real-time.

11. The method of claim 9, wherein the each of the first employer data set and the second employer data set comprise employee date of hire, employee date of termination, employee beginning job title, employee ending job title, and eligibility for rehire.

12. The method of claim 9, wherein the first employer data set comprises a first employer data set usage requirements set and the second employer data set comprises a second employer data set usage requirements set.

13. The method of claim 12, further comprising the step of adhering to the first employer data set usage requirements set and adhering to the second employer data set usage requirements set.

14. The method of claim 11, further comprising the step of rendering, on the user interface, the first employee candidate timeline comprising a set of first employee candidate timeline tenure blocks defined by the first employer data set and the second employer data set.

15. The method of claim 14, further comprising the step of table rendering, on the user interface, any first employee candidate timeline tenure gaps that exceed a selectable tenure gap threshold.

16. A verified automated employment screening system comprising:
a logic engine comprising a computer processor, the computer processor operating to: receive employment data from a plurality of data sources comprising a plurality of employers, receive benchmark employment data comprising average tenure data, and calculate one or more a system scores comprising a first employee candidate screening score and a second employee candidate screening score;
a system database having a non-transitory computer-readable storage medium, the system database storing the employment data and storing the benchmark employment data, the employment data comprising at least: i) a first employer data set from a first employer and associated with a first employee candidate, ii) a second employer data set from a second employer and associated with the first employee candidate, iii) a third employer data set from a third employer and associated with a second employee candidate, ii) a fourth employer data set from a fourth employer and associated with the second employee candidate; and
a user interface operating to present the one or more system scores to a user and to receive one or more data analysis settings comprising a below average threshold percentage and an above average threshold percentage;
wherein:
each of the first employer data set, the second employer data set, the third employer data set, and the fourth employer data set comprise employee date of hire, employee date of termination, employee beginning job title, employee ending job title, and eligibility for rehire; and
the logic engine has machine-executable instructions operating to:
automatically calculate the first employee candidate screening score based at least on the first employer data set, the second employer data set, the average tenure data, the below average threshold percentage, and the above average threshold percentage;
automatically calculate the second employee candidate screening score based at least on the third employer data set, the fourth employer data set, the average tenure data, the below average threshold percentage, and the above average threshold percentage;
render, on the user interface, the first employee candidate screening score and the second employee candidate screening score; and
render, on the user interface, each of: i) a first employee candidate timeline comprising a set of first employee candidate timeline tenure blocks defined by the first employer data set and the second employer data set, and ii) a second employee candidate timeline comprising a set of second employee candidate timeline tenure blocks defined by the third employer data set and the fourth employer data set.

17. The system of claim 16, wherein each of the first employer data set, the second employer data set, the third employer data set, and the fourth employer data set comprise employee date of hire, employee date of termination, employee beginning job title, employee ending job title, and eligibility for rehire.

18. The system of claim 16, wherein the first employer data set comprises a first employer data set usage requirements set, the second employer data set comprises a second employer data set usage requirements set, the third employer data set comprises a third employer data set usage requirements set, and the fourth employer data set comprises a fourth employer data set usage requirements set.

19. The system of claim 16, wherein the logic engine further comprises machine-executable instructions operating to adhere to each of: i) the first employer data set usage requirements set, ii) the second employer data set usage requirements set, iii) the third employer data set usage requirements set, and iv) the fourth employer data set usage requirements set.

20. The system of claim 16, wherein at least one of the first employer data set, the second employer data set, the third employer data set, and the fourth employer data set are encrypted.
